(19) United States
(12) Patent Application Publication
(10) Pub. No.: US 2003/0064183 A1
(43) Pub. Date: Apr. 3, 2003

(54) Magnet set support envelope and attachment to a sheet

(76) Inventor: Craig Miller, Yorba Linda, CA (US)

Correspondence Address: David T. Bracken, The Law Office of David T. Bracken, 4839 Bond Avenue, Orange, CA, 92869, US

(21) Appl. No.: 09/967,304

(22) Filed: Oct. 1, 2001

(51) Int. Cl. B32B 1/02

(52) U.S. Cl. 428/35.7; 156/272.2

(57) ABSTRACT

The present invention comprises a polymer envelope about a magnet set, preferably a magnet set with four adjacent cylindrical magnets and metal washer on a top side. The envelope is formed from two laminar polymer sheets, a top and bottom sheet, bonded by dielectric (RF) heating generally about the lateral edges of the magnet set. It has been surprisingly found that upon cooling, the shrinkage of the sealed envelope is sufficient to form a slightly tensioned envelope capable of providing superior support and comfort to the prior art envelopes. It is a further invention herein that the material of the envelope may in the same dielectric heating step be so strongly bonded to laminar or woven flexible sheet material that the magnet set will remain appropriately bonded to the flexible sheet through all the magnetic therapy uses now required for such flexible sheets.

### BACKGROUND OF THE INVENTION

The present invention relates to magnets arranged in sets and aligned for encapsulation into magnetic therapy devices.

Magnetic therapy practice has caused the development of products with permanent magnets distributed on the products. For example, U.S. Pat. No. 4,509,219 teaches a sleeping mattress structure provided with permanent magnets each having a magnetic field strength of at least 850 gauss which are disposed on the mattress for maximum magnetic curing effect. U.S. Pat. No. 4,921,560 teaches a method for fixing the permanent magnets to bed covering. Merchandise worn by humans having magnetic structure has also been developed. For example, Japan Life Products 1992 Catalog, at page 10 and 11, show belts, elbow and knee supporters, wrist and foot support massager provided with magnetic structure. Similarly, present day magnetic therapy merchandise includes head bands, vests, belts, wrist bands, supports for the elbows, arms, legs, knee and ankle, and also necklaces.

The apparent premise for the merchandise provided with the magnetic structure is to place a permanent magnet such that body cells are exposed to a low-level magnetic field emitted from the permanent magnets. The magnetic exposure is believed to assist stressed cells in restoring their correct balance of electrical charge for performing more efficiently, see undated article by Japan Life Products, entitled: “Spreading Good Sleep Around the World”. The magnetic exposure when concentrated at the same specific points on the body known to acupuncture and accupressure practitioners is a developing therapeutic practice.

An especially effective form of an arrangement of magnets for application to directly on the human skin, or within one to two layers of natural or synthetic material or sheet polymer, has been shown to be a set of magnets of about the same cross sectional area is several permanent magnets are required to produce the maximum magnetic exposure.

In U.S. Pat. No. 4,587,956 it is disclosed that opposite magnetic poles have unique therapeutic effects on body tissues. That patent discloses that flux from a north pole of a magnet if applied in effective levels in the order of at least 200 gauss per square inch has a sedator effect, reduces pain, mobilizes calcium, relieves muscle spasms, increases joint mobility and lowers the pH of the affected tissues. By contrast, flux from a south pole of a magnet stimulates circulation, speeds healing time, strengthens tissues, and raises the pH to a weak alkaline condition characterizing healthy tissue. It is further disclosed that the north pole flux may reduce the electrogalvanic potential across the nerve sheaths in the affected tissue to a value substantially below that recognized by the brain as a pain signal; and that the south pole flux, if applied subsequently, does not raise the potential to a value which the brain would recognize as a pain signal, thus it can effect healing while enabling normal exercise without pain.

A prior art magnet set of four adjacent magnets is known to engage the cooperative magnetic strength of side by side magnets and to at the same time provide enhanced equal and opposite polar magnetic effects. FIGS. 1-3 are exemplary of these arrangements, referred to herein as a magnet set. In the prior art and incorporated into certain magnetic therapy products sold in products by the Amway Corporation, a two layer polymer envelope is in one layer vacuum formed in substantially the shape of the lateral sides outline and metal washer top of the magnet set and tightly bonded at the bottom outline edges to a flat sheet. This polymer envelope provides adequate support for the magnet set incorporated into flexible sheets, although its incorporation therein is an expensive and not always adequate method of maintaining the enveloped set in place on the flexible sheet. The magnet set itself must remain substantially planar through manipulation of the planar flexible sheets during therapy or use by the person wishing to lie close to the top or bottom sides of the magnet set with comfort. The effectiveness of the magnet set is greatly reduced if the one of the magnets falls out of the adjacent plane as shown in FIGS. 1-3, so the enclosing envelope must not only keep the magnets of the magnet set together, the envelope must maintain the planar arrangement. In the prior art, the magnet set has been found to be advantageously incorporated into a woven polymer or natural fiber material for articles such as quilts, blankets, and bed sheets although maintaining the general planarity of the magnet set with the flexing nature of the woven materials has become an important problem. The polymer envelope must be indirectly secured to the woven materials with glue (as in the case of fiber filled articles) or being overlain with a second layer of woven material, the second layer then being sewn to the base layer. The typical flexible sheet incorporating magnet sets requires many such magnet sets, thereby dramatically increasing the cost and complexity of forming the flexible sheet with the magnet sets. There is a need for a more simply formed envelope for the magnet sets and a simpler and less expensive method for securing attachment of the magnet set envelope to woven or laminar flexible sheets.

### SUMMARY OF THE INVENTION

The present invention comprises a polymer envelope about a magnet set, preferably a magnet set with four adjacent cylindrical magnets and metal washer on a top side. The envelope is formed from two laminar polymer sheets, a top and bottom sheet, bonded by dielectric (RF) heating generally about the lateral edges of the magnet set. It has been surprisingly found that upon cooling, the shrinkage of the sealed envelope is sufficient to form a slightly tensioned envelope capable of providing superior support and comfort to the prior art envelopes. It is a further invention herein that the material of the envelope may in the same dielectric heating step be so strongly bonded to laminar or woven flexible sheet material that the magnet set will remain appropriately bonded to the flexible sheet through all the magnetic therapy uses now required for such flexible sheets. For instance, a stretchable cotton material such as used in T-shirts can be bonded about the polymer envelope to form a woven material envelope such that the sheet to which it is bonded may be vigorously machine washed many times without any loss of securement of the polymer envelope to the woven material.

In addition, an invention manufacturing process comprises performing the above polymer envelope formation or polymer and woven or laminar material envelope formation such that relatively large sheets of such woven or laminar material may have many magnet sets bonded to them in a single dielectric heating step. Such large sheets of woven or laminar material comprise vinyl for waterbeds or air beds and cotton, wool or synthetic fiber sheets used for articles of clothing or bedding.

### BRIEF DESCRIPTION OF THE DRAWINGS

FIGS. 1-3 are respectively top separated, top brought together and top oblique views of 4 cylindrical sections of magnetized material having their cylinder tops arranged so that diagonal cylinders tops are of the same, opposing poles and side by side cylinders tops are of opposite, attracting poles, thereby forming a magnetic unit.

FIG. 4 is a top view of four extensions from an electrode plate for a dielectric heating (RF welding) device adapted to form four polymer envelopes or polymer and woven or laminar material envelopes.

FIG. 5 is a close up of an extension of FIG. 4.

FIG. 6 is section AA of FIG. 5.

FIGS. 7-9 are side and cut away views of respectively placement of a magnet set and polymer envelope and woven or laminar material envelope within means for dielectric heating as in FIGS. 5 and 6, compression of the layers of FIG. 7 in the dielectric heating means, and dielectric heating of the layers of polymer and woven or laminar material.

FIG. 10 is is a side and cut away view of the cooled and enveloped magnet set as shown in FIG. 10.

FIG. 11 is a side and cut away view of the cooled and enveloped magnet set as shown in FIG. 10, however formed without the woven or laminar material, showing the polymer envelope about the magnet set alone.

FIGS. 12 and 14 are top views of the enveloped magnet set of FIG. 10.

FIG. 13 is a perspective view of the bottom electrode and wells formed therein for the invention dielectric heating, also showing placement of a magnet set, a sheet of polymer material, and underneath a layer of woven or laminar material.

FIG. 15 shows the invention magnet set incorporated into a sheet of flexible material for a waterbed or airbed.

### DETAILED DESCRIPTION OF THE INVENTION

The invention is now discussed with reference to the Figures.

Envelope can be double or single; sheet can be double or single; 42×51 sheet at a time; 8 inch centers staggered 4 inches; comfort determines upper height for magnets; super strong magnets held planar with same envelope; washer not needed but is preferred; 18-200 megacycles per second at 1.2-1.5 milliamp for welding flexible PVC; inventor of magnet set with washer is Holcomb? (Craig will investigate)

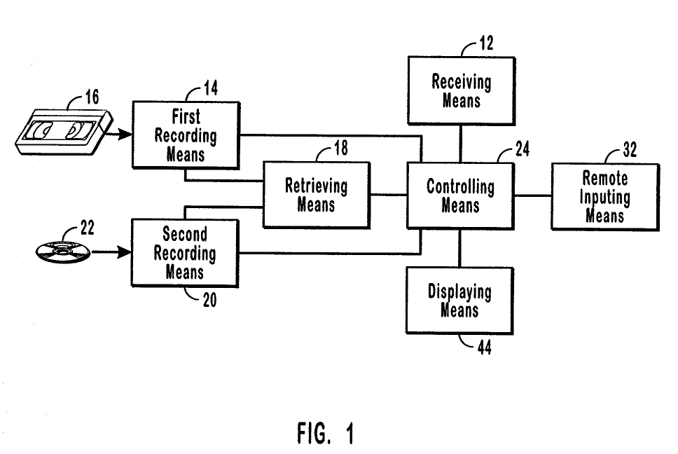

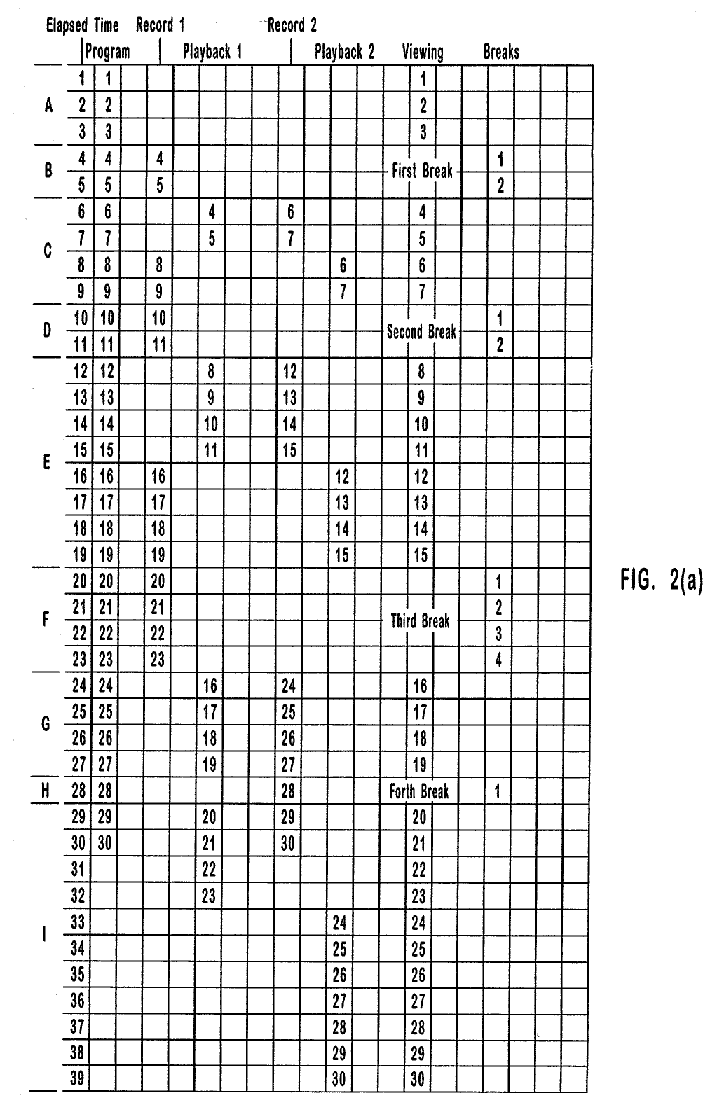

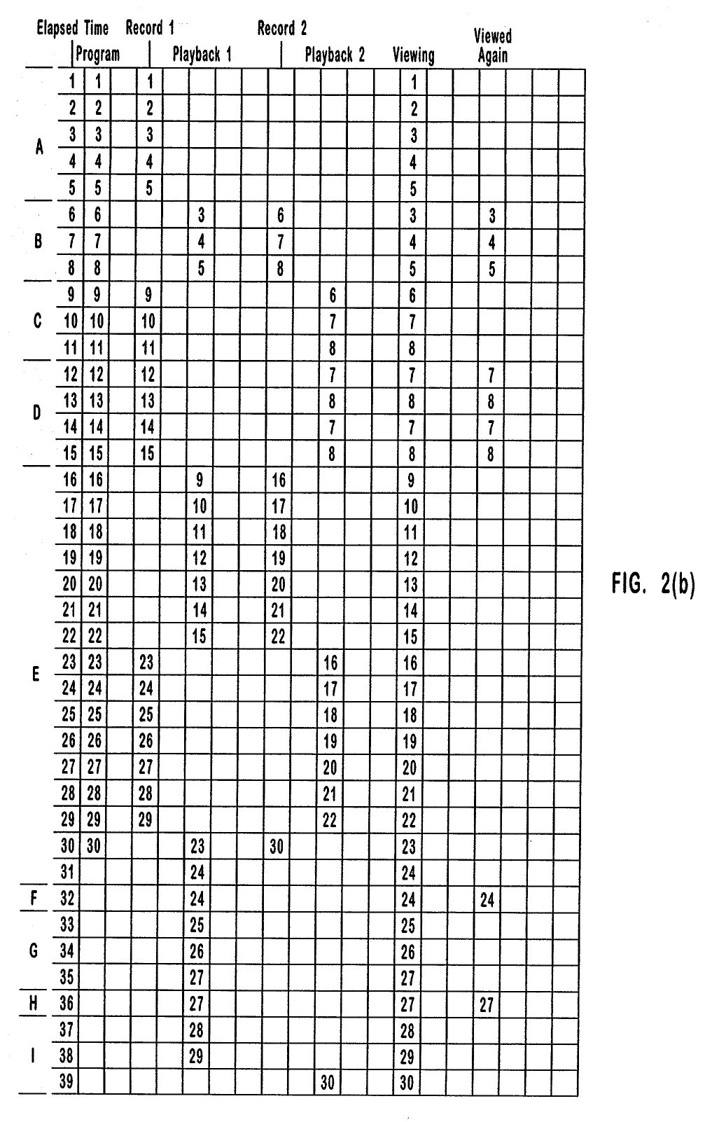

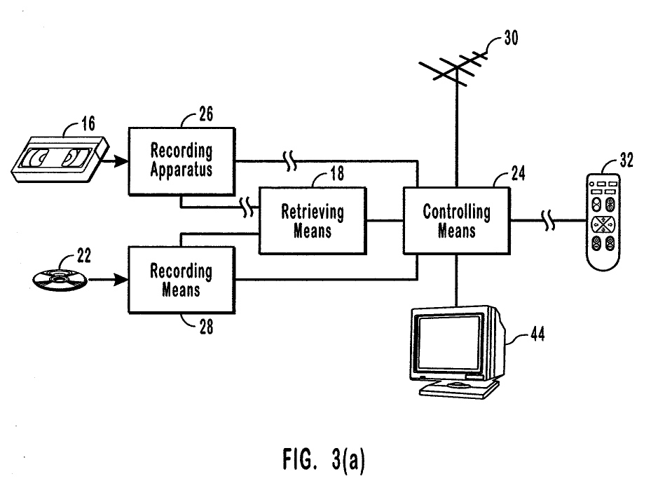

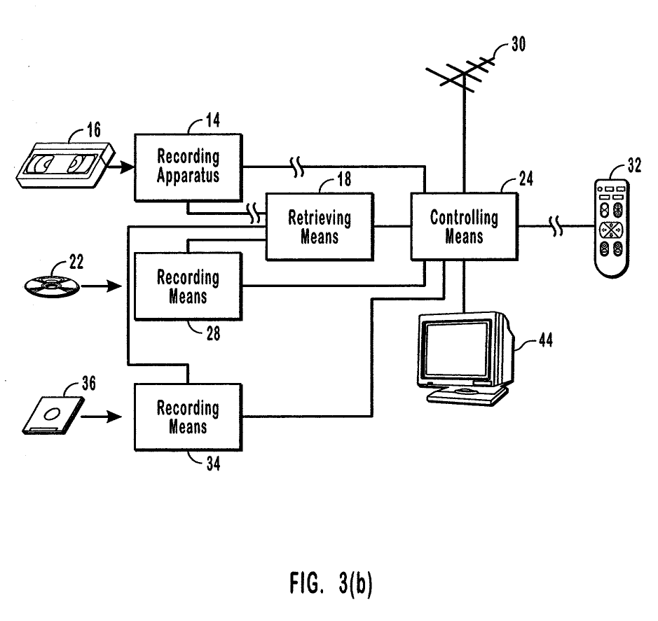

A current form of a ‘magnet pack’ of four side by side magnets is shown in FIGS. 1-3. For short cylindrical magnets 101, with a cross section diameter of from about less than about 0.25 inches to above about 1½ inches and a thickness of less than about 0.5 inches, are arranged so that their square ‘set’ 100 is maintained by the adjacency of opposite poles causing attractions 102. Thus, the set 100, unless in contact with magnetizable surfaces, tends to remain together on a table top or horizontal surface. However, in mass production, bringing into side by side relation more than one set clearly is a disadvantage—the magnets of the other set tend to either repel or attract the magnets of a nearby set and thereby disaggregating the sets and requiring hand re-assembly of the sets. Thus, an uneconomical amount of space and hand work is required to assemble the sets for encapsulating in a sufficiently rigid polymer or other containing means so that the set 100 magnets do not simply fall out of the planar alignment and disturb the Gaussian field concentration of that planar arrangement for substantially flexible body surface application of the set.

Each set 100 typically has applied to a top side a flat metal piece such as a washer with an outside diameter less than the plane width of the set 100 for enhancement of the collective magnetic field and for additional planar support, encapsulated as just described, and then combined in a supportive way to some flexible sheet material so that the material may be brought into close proximity to the curved surface of a human body for magnetic therapy treatment. The formation and assembly segregation of sets 100 has in the prior art required the use of all hand labor.

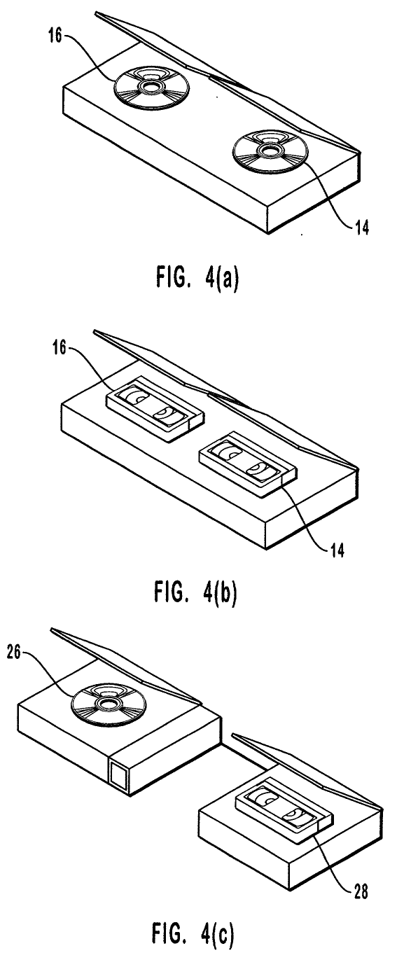

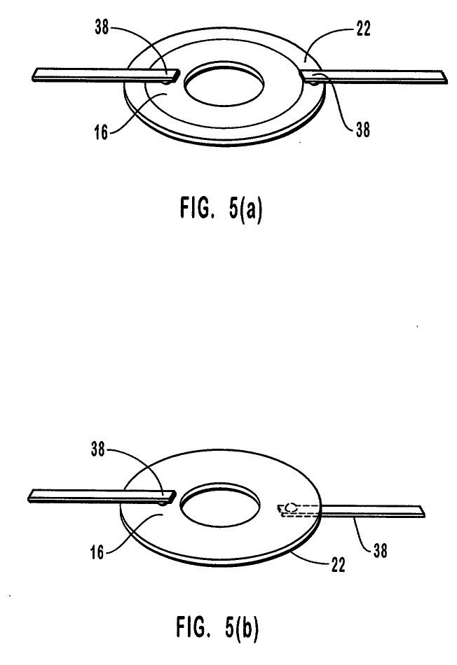

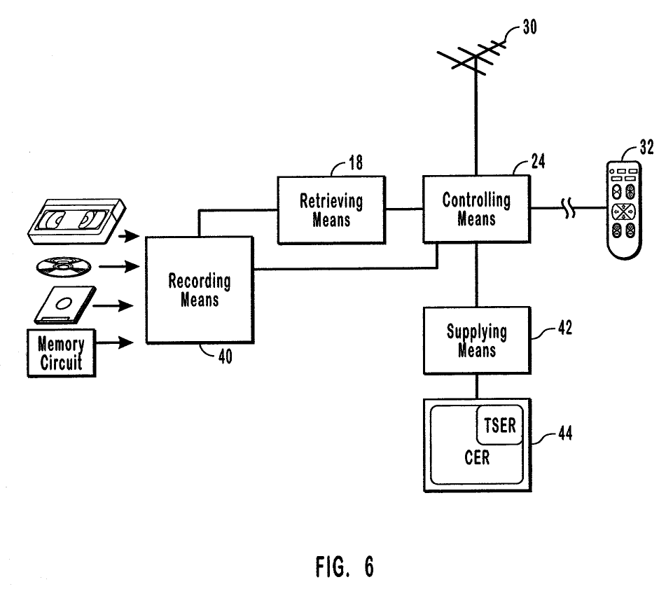

Dielectric heating or RF welding uses frequencies from 18 to about 200 megacycles per second. The present invention uses such means for heating polymer sheets sufficiently to form a water and gas tight seal about a magnet set so that the planar orientation of the magnet set 100 is maintained. A top electrode plate 201 in FIGS. 4-6 comprises extensions 200 comprising a shaft 202, a well 204 at the end of the shaft 202, thereby forming dielectric rim 203 which acts as one of the two electrode surfaces to primarily transmit the current used for the dielectric heating for the invention.

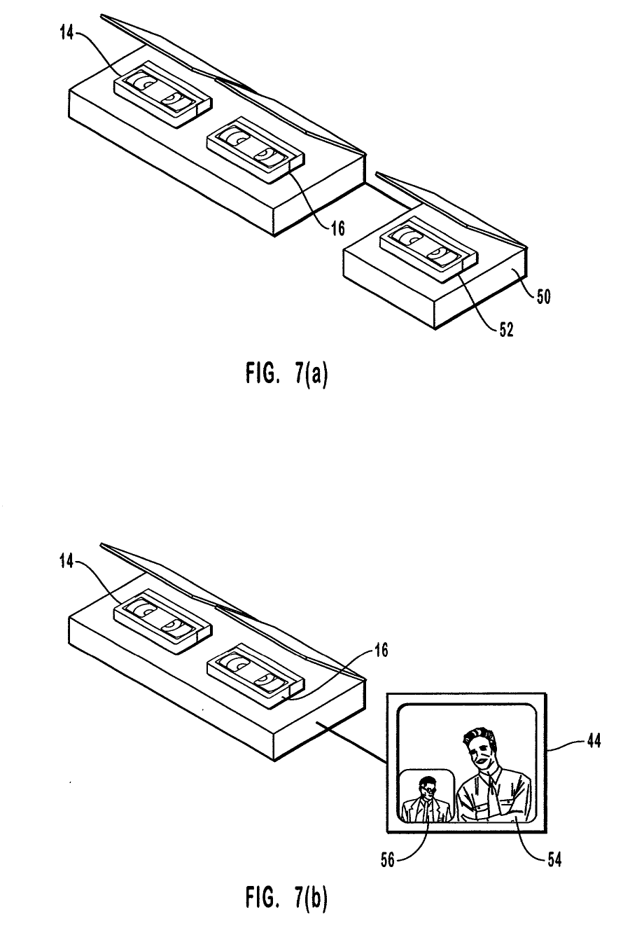

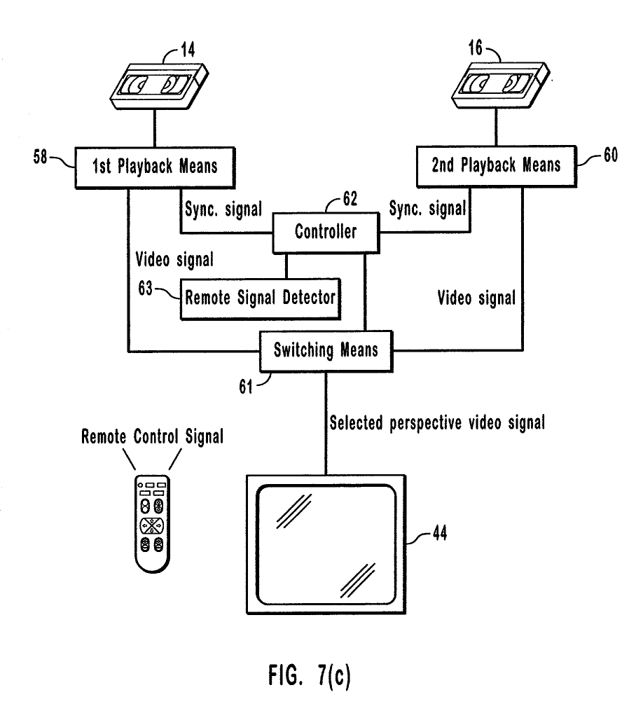

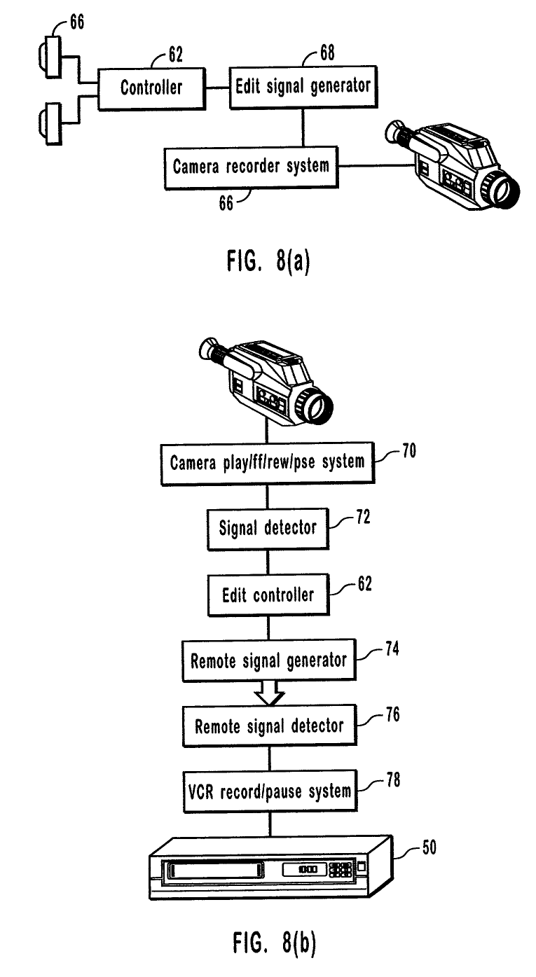

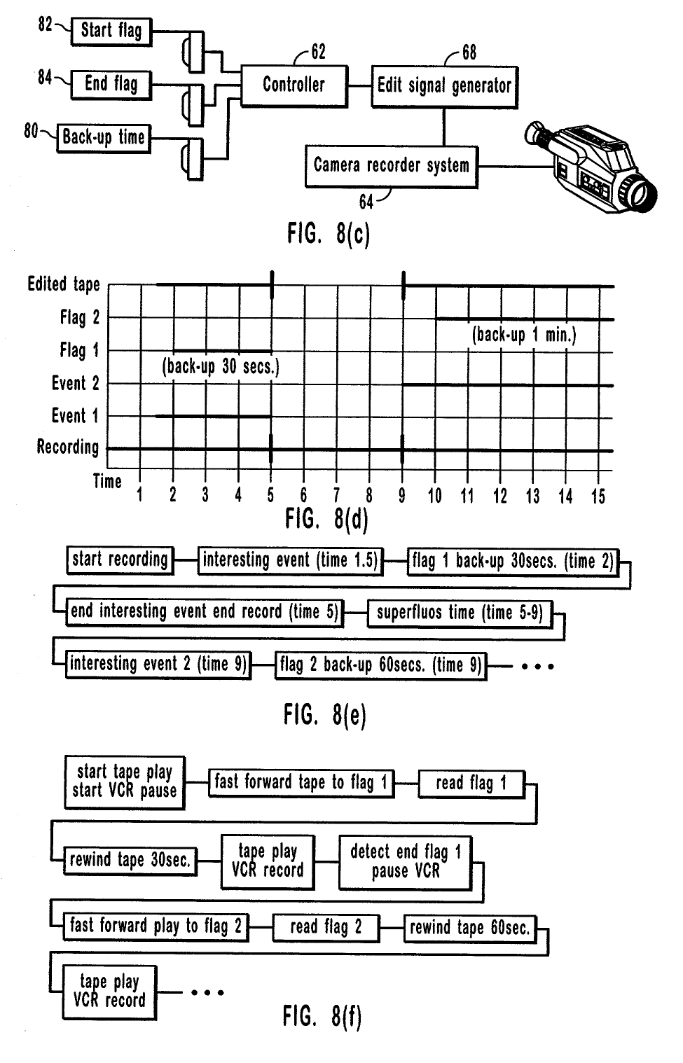

With reference to FIG. 7, rim 203 is aligned above a well 207 is formed in non-metallic plate 205 and is just slightly greater in lateral width than an axial cross section of the rim 203, whereby rim 203 can be lowered into well 207 to bring rim 203 into close proximity with bottom electrode plate 206. Magnet set 100 is arranged between sheets 209 and 210, which are in turn arranged between sheets 208 and 211. The process of forming a polymer envelope and/or polymer and woven or laminar material envelope for set 100 is shown in FIGS. 8-11. FIG. 7 shows that bonds shall be made continuously about a circumference of set 100 at interlayer circumferences 212-214. The most important of the bonds being along circumference 213 to establish the polymer envelope. Sheets 209 and 210 comprise one or more (preferably one) polymer sheets capable of bonding by heat or dielectric heat sealing and with sufficient thickness to accomplish the objects of the invention, preferably with a thickness of from about 2 to 30 mils, but economically more preferably from about 4 to 10 mils. To accomplish the dielectric heating of the invention, a current of about 1.5-2.5 milliamps is preferred for sufficient bonding of flexible PVC for formation of both the polymer envelope alone or with the additional enveloping layer or layers of woven or laminar material.

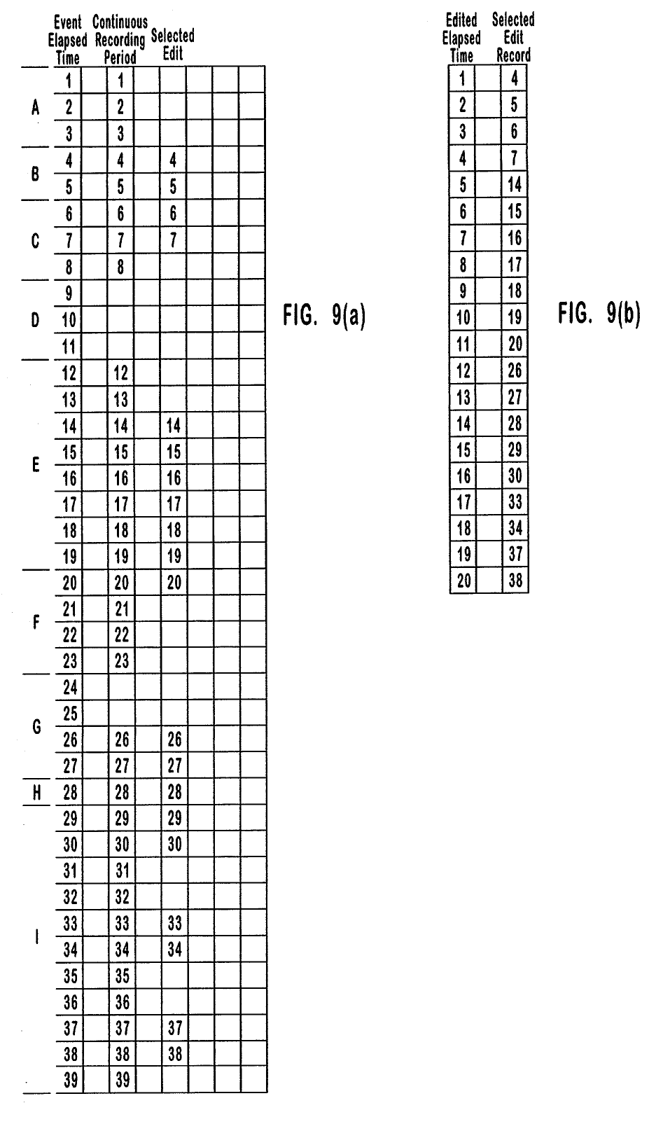

FIG. 8 shows that rim 203 presses layers 208-211 together about the lateral circumference of set 100. In this position, the current to the dielectric heating means may be applied to produce the result shown in FIG. 9. In FIG. 9, layers 209 and 210 are fused together although still substantially heated to form bond circumference 213. Sufficient of the polymer from layers 209 and 210 has respectively diffused the adjacent woven or laminar layers 208 and 211 such that an effectively supportive bond is formed and circumferences 212 and 214.

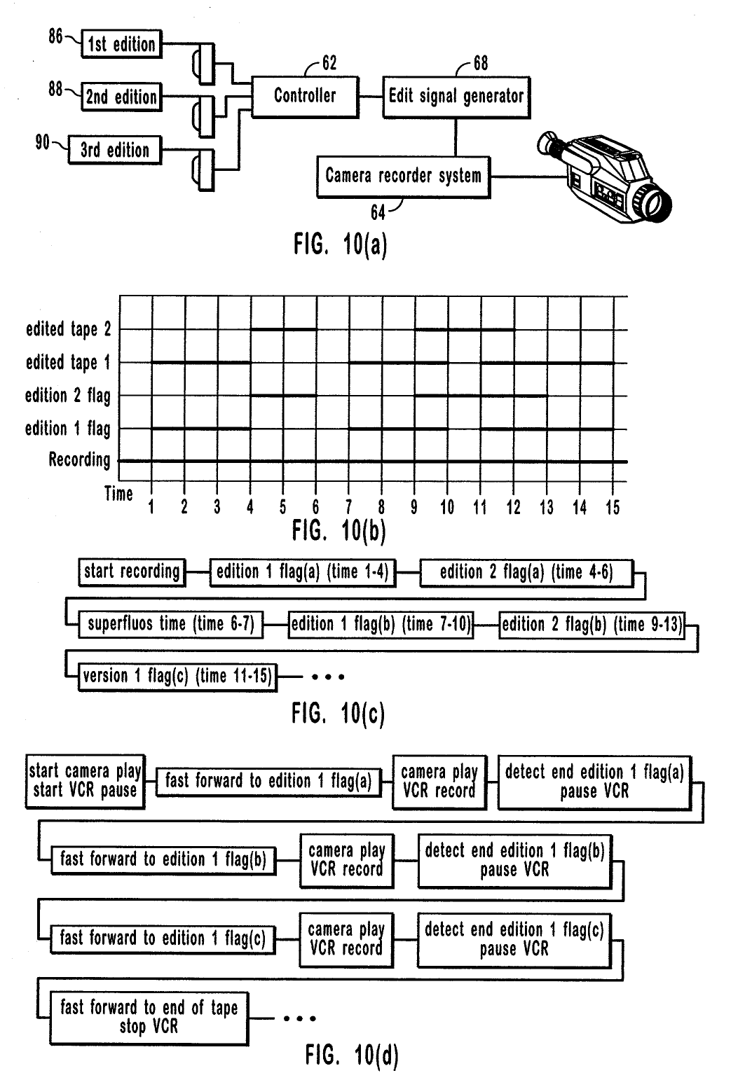

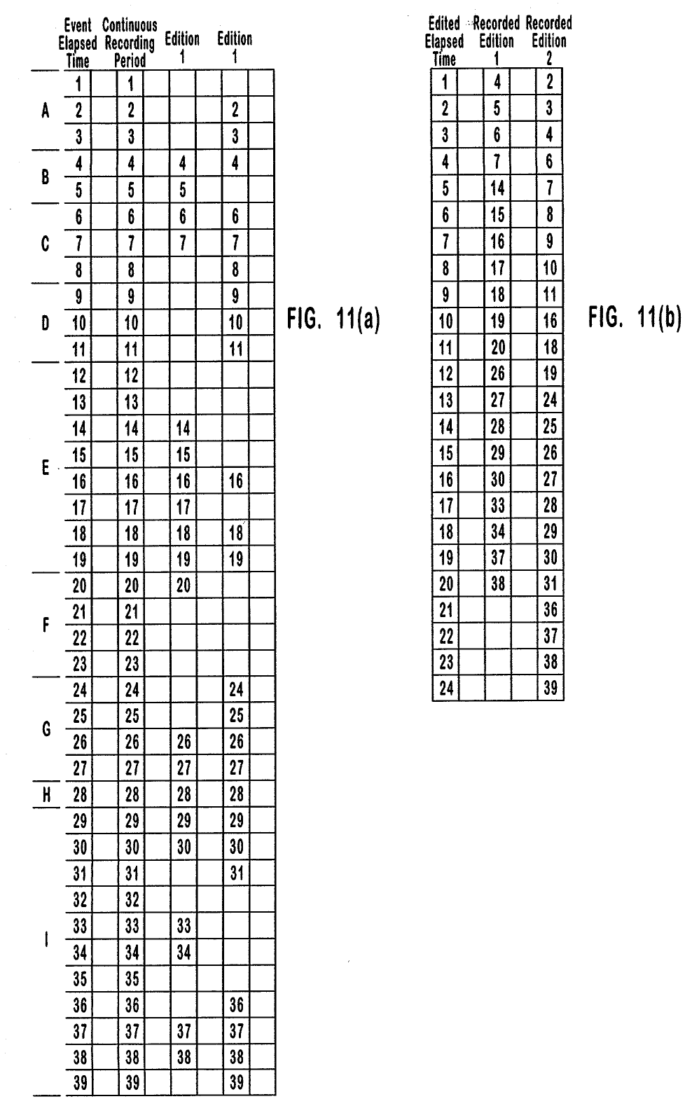

FIGS. 10 and 11 display a surprising feature of the present polymer envelope. The cooling process for the polymer of layers 209 and 210 after dielectric heating causes just sufficient shrinkage to form a tensioned polymer envelope as shown in FIGS. 10 and 11. The shrinkage moves along directions 215 such that what was a substantially bottom layer planar attachment along circumference 213 as shown FIG. 9 to a substantially lateral position in FIGS. 10 and 11, thereby providing anti-biasing support for the magnet set with tensioned top surface layer 216 and bottom surface layer 217.

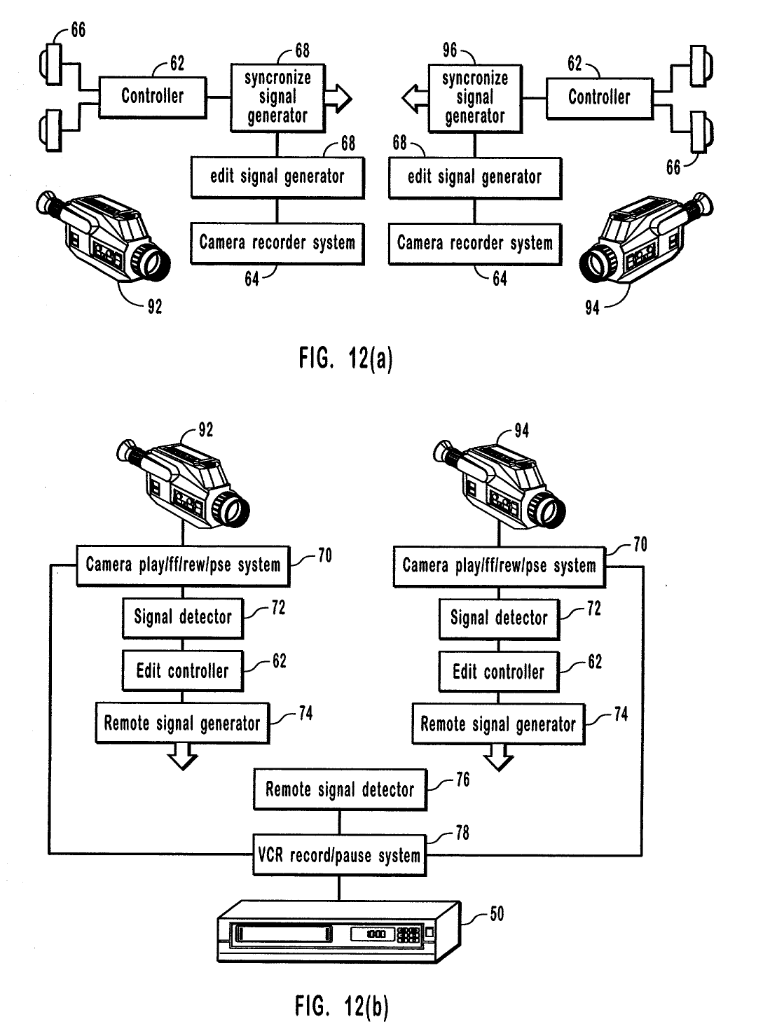

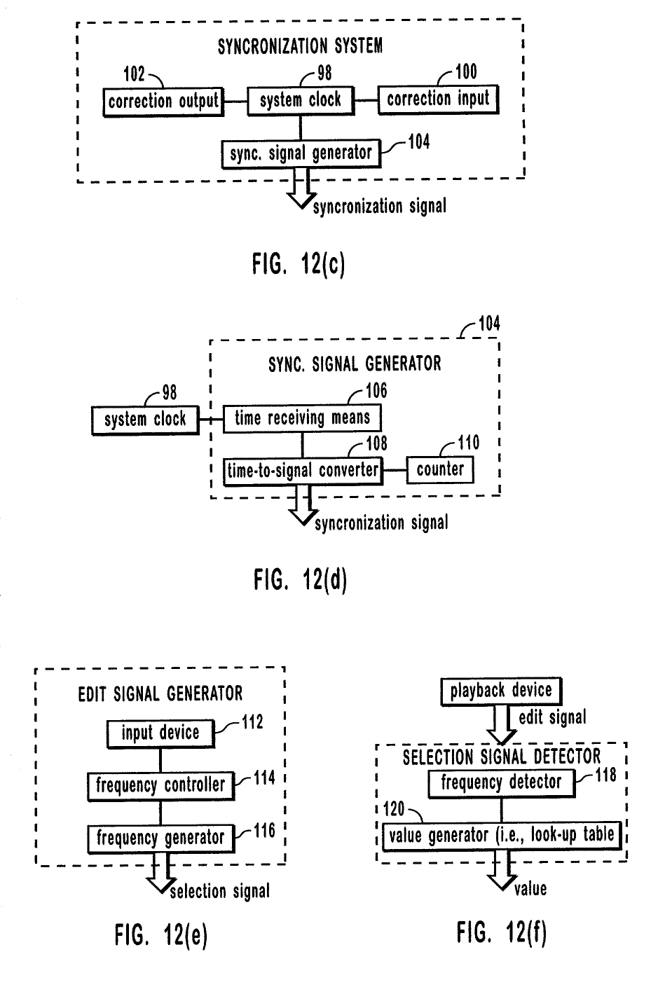

In addition, the melt fusing of the flexible sheets 208 and 210 to the polymer envelope bond circumference eliminates the need for post-envelope formation attachment to a flexible sheet. FIGS. 12 show the smooth, tensioned enveloping of layers 208 and 211 about the polymer envelope for set 100. These sheets of woven or polymeric material with sets 100 may be located within a loft-inducing fiber fill for padding, whereby the layers may be quilted together for additional orientation securement of sets 100 for conformation to a user's body contours.

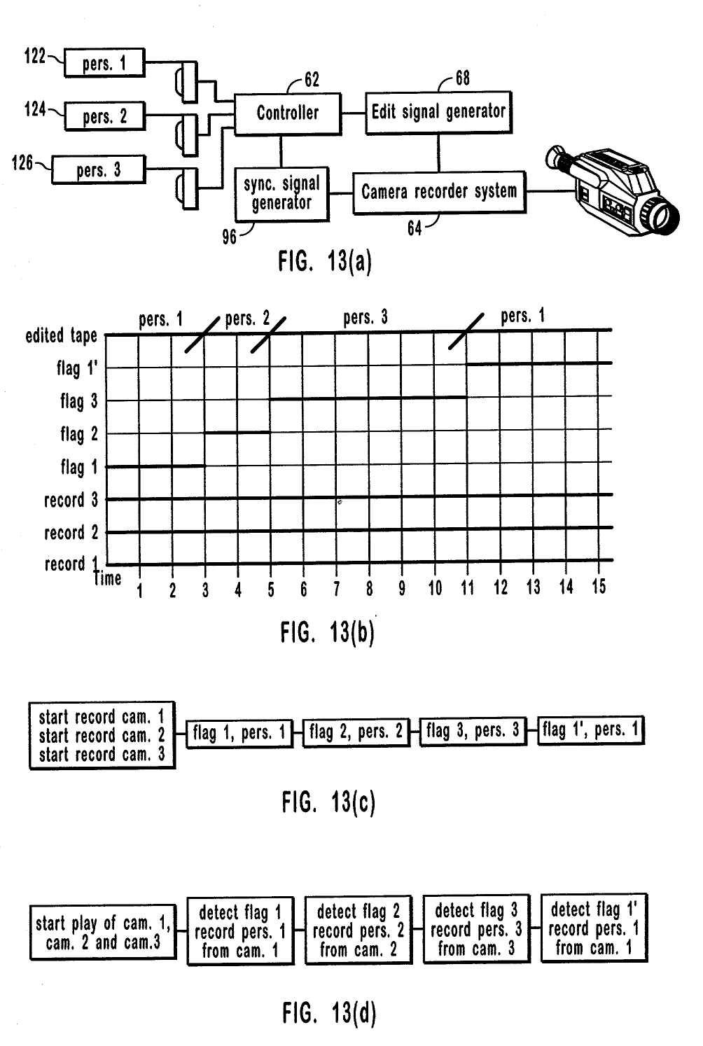

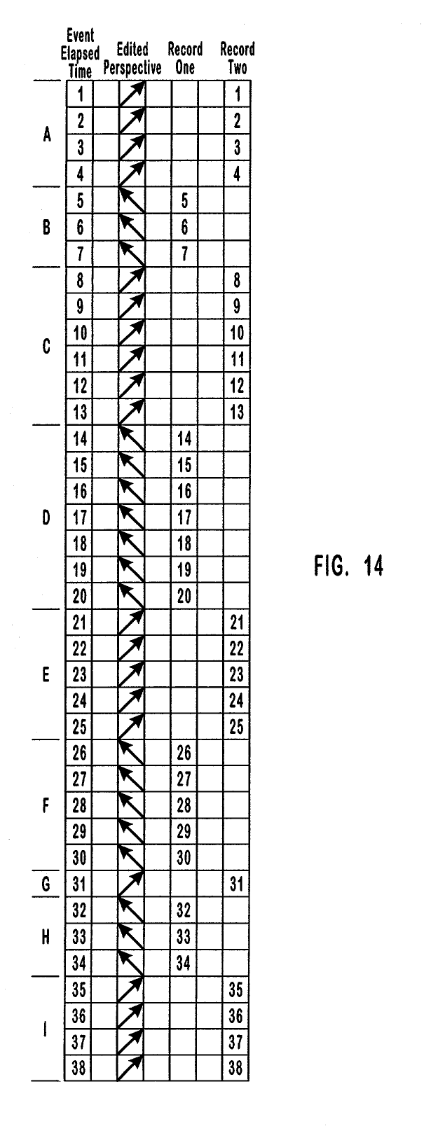

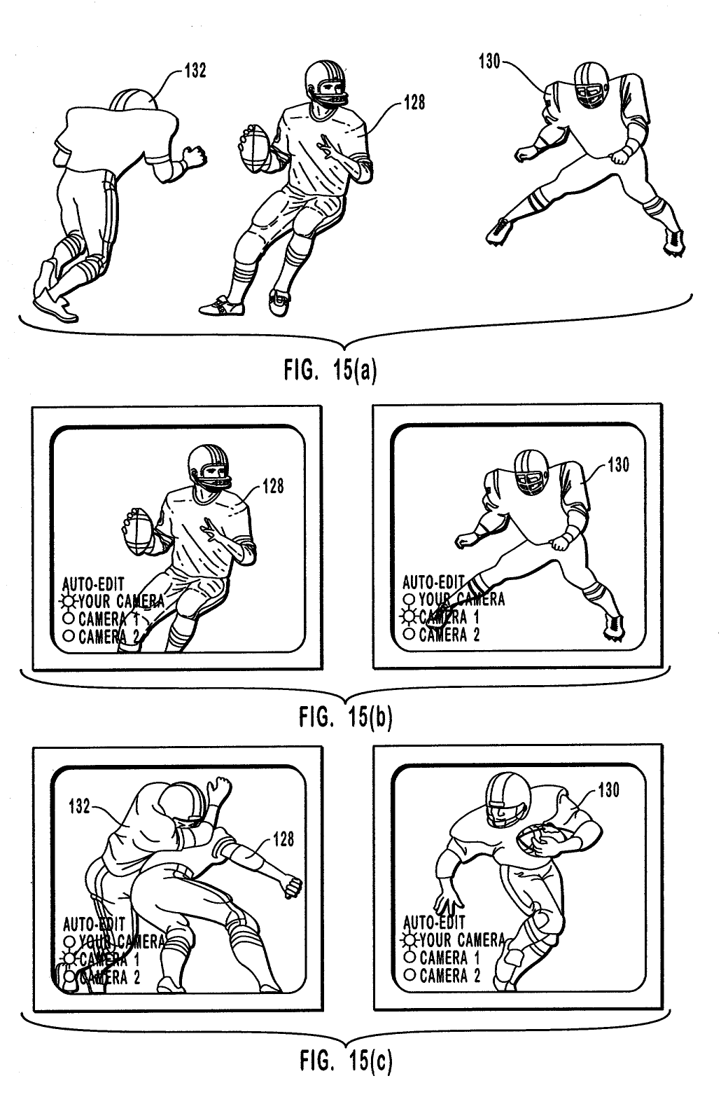

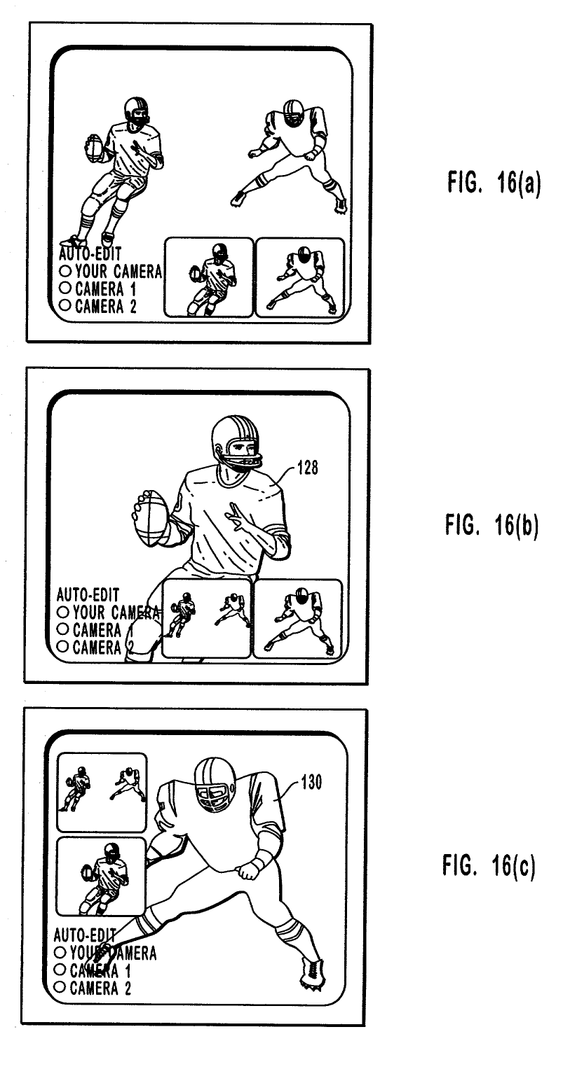

FIG. 13 shows a perspective view of the wells 207 on a bottom electrode plate 206, the wells being formed of a non-conductor, non-magnetic material for aligning the set 100 and layers 108-111 within each well 207. FIG. 15 shows a flexible laminar PVC sheet as for waterbeds and airbeds incorporating the polymer envelope about one or more magnets sealed as above by dielectric heating.

The above design disclosures present the skilled person with considerable and wide ranges from which to choose appropriate obvious modifications for the above examples. However, the objects of the present invention will still be obtained by the skilled person applying such design disclosures in an appropriate manner.

I claim:

1. A polymer envelope for a magnet set, the magnet set comprising a first top side, a first bottom side, four flat and substantially identical magnets having lateral sides and magnetic poles on second top and bottom sides, the magnets arranged adjacently to their lateral sides such that immediately adjacent magnets have opposite magnetic polarities at their second top and bottom poles, the improvement comprising:
(a) a top polymer sheet slightly tensioned against the first top side and a bottom polymer sheet slightly tensioned against the first bottom side, the top and bottom polymer sheets extended laterally and forming a lateral seal closely circumferential to the lateral sides of the magnet set and located between planes formed by the first top and first bottom sides.

2. The envelope of claim 1 wherein a layer of a woven or laminar material is located against an outside surface of the top or bottom polymer sheet by bonding to such a sheet at the same outer surface location as the lateral seal.

3. The envelope of claim 1 wherein a layer of a first woven or laminar material is located against an outside surface of the bottom polymer sheet by bonding to such a sheet at the same outer surface location as the lateral seal and a layer of a second woven or laminar material is located against an outside surface of the top polymer sheet by bonding to such a sheet at the same outer surface location as the lateral seal.

4. The envelope of claim 3 wherein the first woven or laminar material extends laterally to form a relatively large flexible sheet adapted to be incorporated into a magnetic therapy piece.

5. A method for forming polymer envelope for a magnet set, the magnet set comprising a first top side, a first bottom side, four flat and substantially identical magnets having lateral sides and magnetic poles on second top and bottom sides, the magnets arranged adjacently to their lateral sides such that immediately adjacent magnets have opposite magnetic polarities at their second top and bottom poles, the improvement comprising:
(a) a top polymer sheet, the magnet set and a bottom polymer sheet layered in that sequence between a top and bottom electrodes of a dielectric heating device;
(b) impressing the top electrode onto the top polymer sheet causing it to contact the bottom polymer sheet, dielectrically heating the polymer sheets to form a seal, cooling the polymer sheets and thereby forming a lateral seal closely circumferential to the lateral sides of the magnet set and located between planes formed by the first top and first bottom sides.

6. The method of claim 5 wherein, in step (a), a layer of a woven or laminar material is located against an outside surface of the top or bottom polymer sheet, thereafter in step (b) bonding to such a sheet at the same outer surface location as the lateral seal.

7. The envelope of claim I wherein, in step (a), a layer of a first woven or laminar material is located against an outside surface of the bottom polymer sheet, thereafter in step (b), bonding to such a sheet at the same outer surface location as the lateral seal and a layer of a second woven or laminar material is located against an outside surface of the top polymer sheet, thereafter in step (b), bonding to such a sheet at the same outer surface location as the lateral seal.

8. The method of claim 7 wherein the first woven or laminar material extends laterally to form a relatively large flexible sheet adapted to be incorporated into a magnetic therapy piece.

9. The method of claim 7 wherein the woven or laminar materials comprise natural or synthetic woven materials.

10. The method of claim 9 wherein the woven or laminar materials comprise a stretchable cotton or cotton and synthetic blend material.
